(19) United States
(12) Patent Application Publication
(10) Pub. No.: US 2021/0106501 A1
(43) Pub. Date: Apr. 15, 2021

(54) Pacifiers and Teething Devices and Related Methods

(71) Applicant: Nippii LLC, South Jordan, UT (US)

(72) Inventor: Ryan Paul Blake, South Jordan, UT (US)

(73) Assignee: Nippii LLC, South Jordan, UT (US)

(21) Appl. No.: 16/826,210

(22) Filed: Mar. 21, 2020

Related U.S. Application Data
(60) Provisional application No. 62/915,486, filed on Oct. 15, 2019.

(51) Int. Cl. A61J 17/00; A61J 17/02

(52) U.S. Cl. CPC A61J 17/008; A61J 2200/44; A61J 2200/42; A61J 17/02

(57) ABSTRACT

Teething devices include a flexible teething member having a hollow interior and partially defining a cavity. A swallow shield coupled with the flexible teething member has a hollow interior and partially defines the cavity. The swallow shield is configured to prevent swallowing of the teething device. A reservoir coupled with the swallow shield has a hollow interior partially defining the cavity. In some implementations an opening in the reservoir provides access to the cavity for introduction and removal of a liquid/gel therefrom, and a closure member is configured to couple with the reservoir in a liquid-tight configuration. In other implementations the cavity is permanently sealed with liquid/gel therein—the teething device including no opening to access the cavity. In implementations the flexible teething member forms a nipple shape. In other implementations it is shaped and sized to simultaneously contact all twenty deciduous teeth of an infant.

### CROSS REFERENCE TO RELATED APPLICATIONS

This document claims the benefit of the filing date of U.S. Provisional Patent Application No. 62/915,486, entitled “Freezable liquid fill-able silicone teether/teething device designed to hold liquids and ice for teething and soothing infant babies,” naming as first inventor Ryan Paul Blake, which was filed on Oct. 15, 2019, the disclosure of which is hereby incorporated entirely herein by reference.

### BACKGROUND

### 1. Technical Field

Aspects of this document relate generally to pacifiers and teething devices.

### 2. Background Art

Pacifiers and teething devices exist in the art. Such devices are configured to allow a baby to suck or chew thereon. There also exist in the art some devices with freezable material therein, the freezable material configured to be frozen to allow a baby to suck or chew on the cold, frozen device.

### SUMMARY

Implementations of oral devices may include: a flexible member having a hollow interior at least partially defining a cavity, the flexible member configured to be used as one of a pacifier and a teething member; a swallow shield coupled with the flexible member and having a hollow interior at least partially defining the cavity, the swallow shield configured to prevent swallowing of the oral device; a reservoir coupled with the swallow shield and having a hollow interior at least partially defining the cavity, the reservoir having an opening providing access to the cavity; and a closure member configured to couple with the reservoir in a liquid-tight configuration to prevent access to the cavity through the opening; wherein the flexible member is formed of a flexible polymer; wherein the opening is configured to allow introduction of a liquid into the cavity and to allow removal of the liquid from the cavity; wherein the flexible member is configured to be one of chewed and sucked, while the liquid is within the cavity, without any of the liquid exiting the cavity; and wherein the oral device is configured to allow freezing of the liquid within the cavity without removing the liquid-tight configuration of the closure member and without rupturing the oral device.

Implementations of oral devices may include one or more or all of the following:

The flexible member may include a flexible teething member sized and shaped to simultaneously contact all twenty erupted deciduous teeth of an infant.

The flexible teething member may form a U-shape.

The flexible member may include a flexible nipple.

The oral device may provide no access to the cavity from outside the oral device except through the opening.

The closure member may include an inner coupler and an outer coupler. The inner coupler may be configured to provide a seal at an interior of the reservoir. The outer coupler may be configured to provide a seal at an exterior of the reservoir.

The entire oral device may be formed from the flexible polymer.

The swallow shield may include air holes therethrough.

A flexible coupler may permanently couple the closure member with one or more of the flexible member, the swallow shield, and the reservoir, even when the closure member is not contacting the reservoir.

Implementations of teething devices may include: a flexible teething member having a hollow interior at least partially defining a cavity; a swallow shield coupled with the flexible teething member and having a hollow interior at least partially defining the cavity, the swallow shield configured to prevent swallowing of the teething device; a reservoir coupled with the swallow shield and having a hollow interior at least partially defining the cavity; and a flowable material filling at least a majority of the cavity, the flowable material including one of a liquid and a gel; wherein the flexible teething member is formed of a flexible polymer; wherein the cavity is fully enclosed within the teething device and wherein the teething device includes no opening providing access to the cavity from outside the teething device; wherein the flexible teething member is configured to be chewed, while the flowable material is within the hollow interior of the flexible teething member, without any of the flowable material exiting the cavity; and wherein the teething device is configured to allow freezing of the flowable material within the cavity without rupturing the teething device.

Implementations of teething devices may include one or more or all of the following:

The flexible teething member may be sized and shaped to simultaneously contact all twenty erupted deciduous teeth of an infant.

The flexible teething member may include a flexible nipple having a hollow shaft topped with a hollow rounded tip.

The flexible nipple may have a rounded base coupled with the swallow shield, the rounded base having one of a semi-ellipsoidal shape and a semi-spherical shape.

The flexible polymer may form all of the teething device.

The flexible teething member may have raised bumps and/or raised lines on a surface thereof.

The flexible teething member may form a U-shape.

The swallow shield may have air holes therethrough.

Implementations of pacifier devices may include: a flexible nipple including a hollow shaft topped with a rounded tip, the rounded tip having no opening therethrough, the flexible nipple including a hollow interior at least partially defining a cavity; a swallow shield coupled with the flexible nipple and including a hollow interior at least partially defining the cavity, the swallow shield configured to prevent swallowing of the pacifier device; a reservoir coupled with the swallow shield and including a hollow interior at least partially defining the cavity; and a flowable material filling at least a majority of the cavity, the flowable material including one of a liquid and a gel; wherein the flexible nipple is formed of a flexible polymer; wherein the cavity is fully enclosed within the pacifier device and wherein the pacifier device has no opening providing access to the cavity from outside the pacifier device; wherein the flexible nipple is configured to be chewed, while the flowable material is within the hollow interior of the flexible nipple, without any of the flowable material exiting the cavity; and wherein the pacifier device is configured to allow freezing of the flowable material within the cavity without rupturing the pacifier device.

Implementations of pacifier devices may include one or more or all of the following:

The flexible nipple may have a hollow rounded base coupled with the swallow shield, the hollow rounded base having one of a semi-ellipsoidal shape and a semi-spherical shape.

The swallow shield may have air holes therethrough.

General details of the above-described implementations, and other implementations, are given below in the DESCRIPTION, the DRAWINGS, and the CLAIMS.

### BRIEF DESCRIPTION OF THE DRAWINGS

Implementations will be discussed hereafter using reference to the included drawings, briefly described below, wherein like designations refer to like elements, and wherein elements are not necessarily drawn to scale:

FIG. 1 is an angled top/right side view of an implementation of a pacifier device in an open configuration;

FIG. 2 is a front view of the device of FIG. 1;

FIG. 3 is a rear view of the device of FIG. 1;

FIG. 4 is a right side view of the device of FIG. 1;

FIG. 5 is a top view of the device of FIG. 1;

FIG. 6 is a left side view of the device of FIG. 1;

FIG. 7 is a bottom view of the device of FIG. 1;

FIG. 8 is an angled bottom/right side view of the device of FIG. 1;

FIG. 9 is a cross-section angled bottom/left side view of the device of FIG. 1;

FIG. 10 is a right side view of the device of FIG. 1 in a closed configuration;

FIG. 11 is a top/side view of another implementation of a pacifier device;

FIG. 12 is a bottom/side view of the pacifier device of FIG. 11;

FIG. 13 is a cross-section angled top/side view of the pacifier device of FIG. 11;

FIG. 14 is an angled top/right side view of an implementation of a teething device in an open configuration;

FIG. 15 is a front view of the device of FIG. 14;

FIG. 16 is a rear view of the device of FIG. 14;

FIG. 17 is a left side view of the device of FIG. 14;

FIG. 18 is a top view of the device of FIG. 14;

FIG. 19 is a right side view of the device of FIG. 14;

FIG. 20 is a cross-section top/right side view of the device of FIG. 14;

FIG. 21 is a bottom view of the device of FIG. 14;

FIG. 22 is an angled bottom/right side view of the device of FIG. 14;

FIG. 23 is a left side view of the device of FIG. 14 in a closed configuration;

FIG. 24 is a top/side view of another implementation of a teething device;

FIG. 25 is a bottom/side view of the device of FIG. 24; and

FIG. 26 is a cross-section top/side view of the device of FIG. 24.

### DESCRIPTION

Implementations/embodiments disclosed herein (including those not expressly discussed in detail) are not limited to the particular components or procedures described herein. Additional or alternative components, assembly procedures, and/or methods of use consistent with the intended pacifiers and teething devices and related methods may be utilized in any implementation. This may include any materials, components, sub-components, methods, sub-methods, steps, and so forth.

While certain devices herein are called “teething devices” and others are called “pacifier devices,” it is to be understood that any of the teething devices disclosed herein may also be accurately called pacifier devices inasmuch as they may be used to pacify infants, and it is also to be understood that any of the pacifier devices disclosed herein may also be accurately called teething devices inasmuch as they may be used to alleviate pain and/or irritation during infant teething.

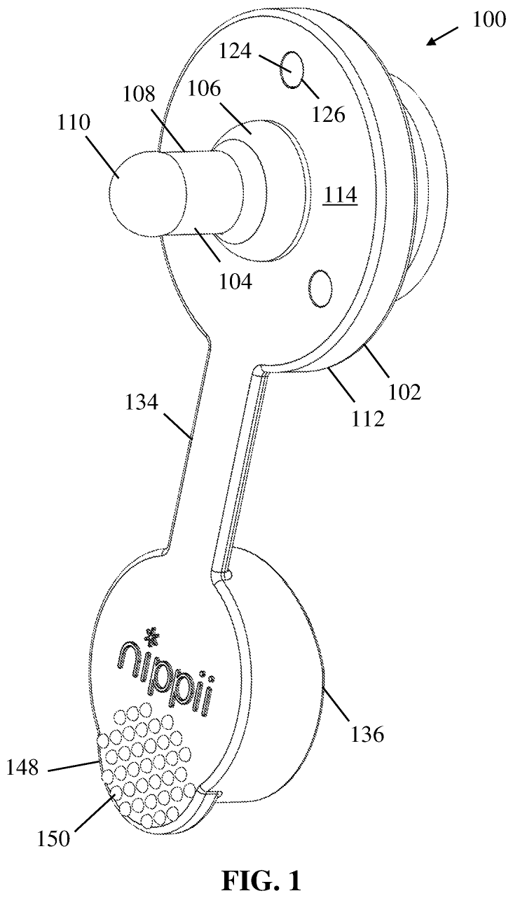

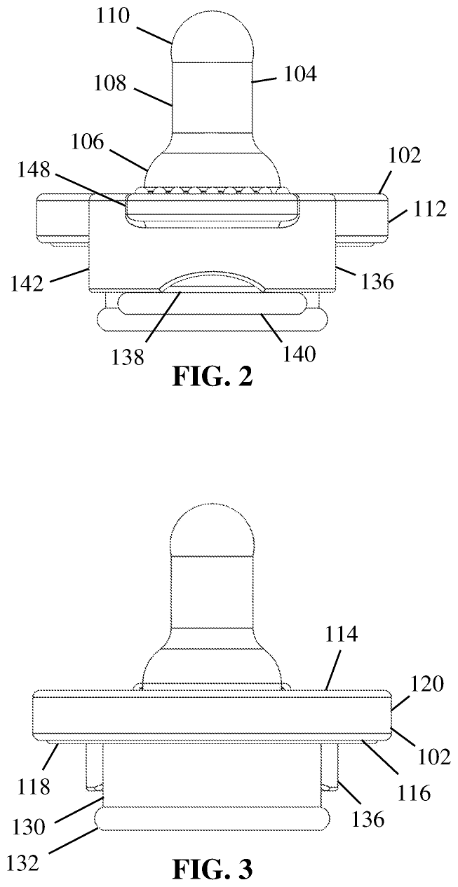

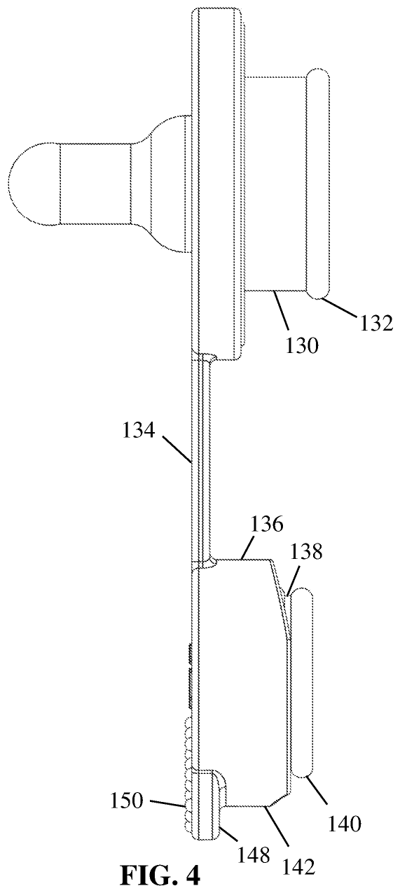

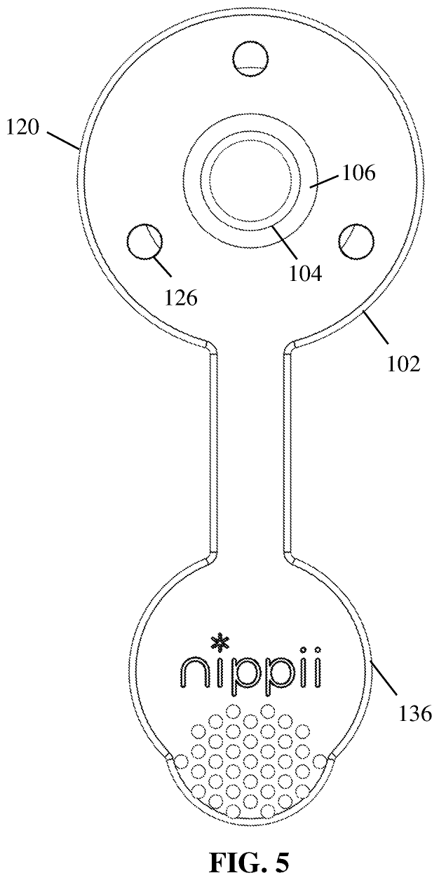

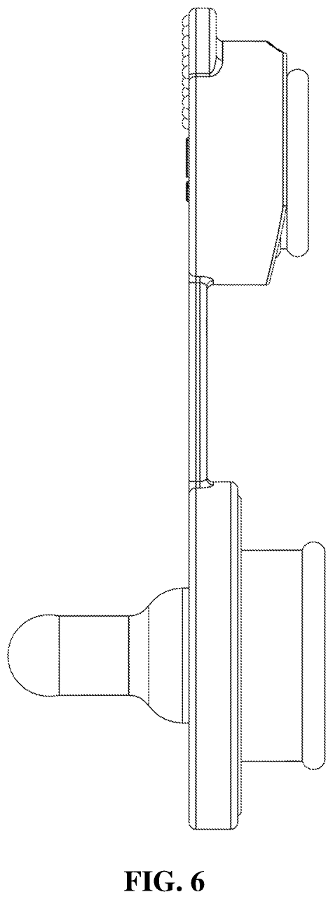

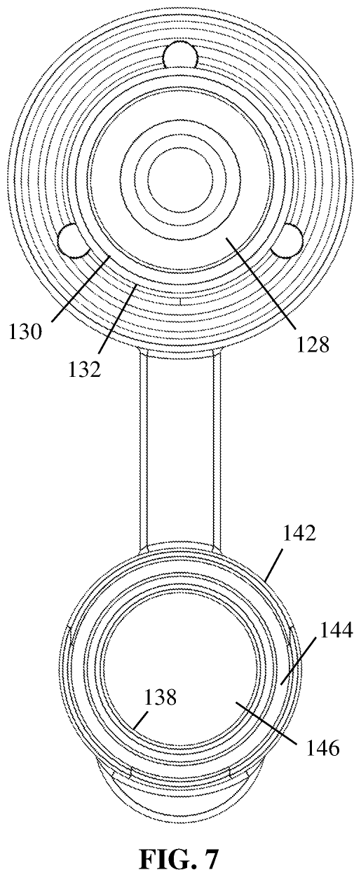

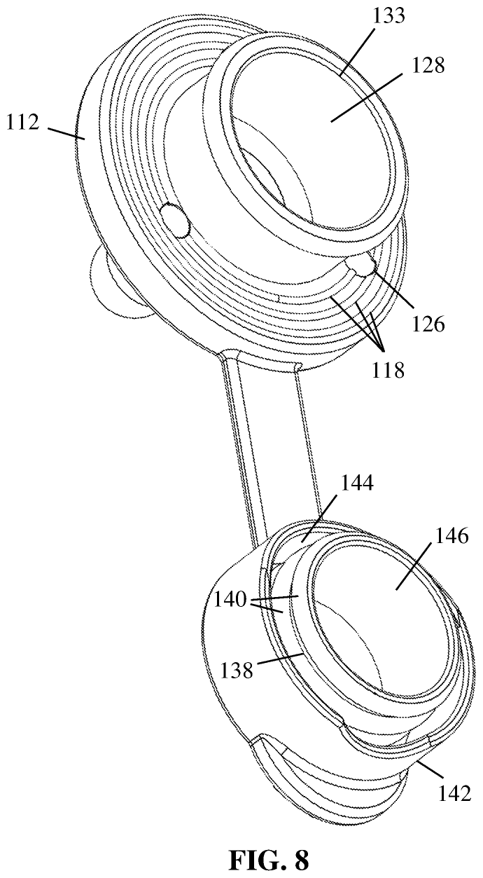

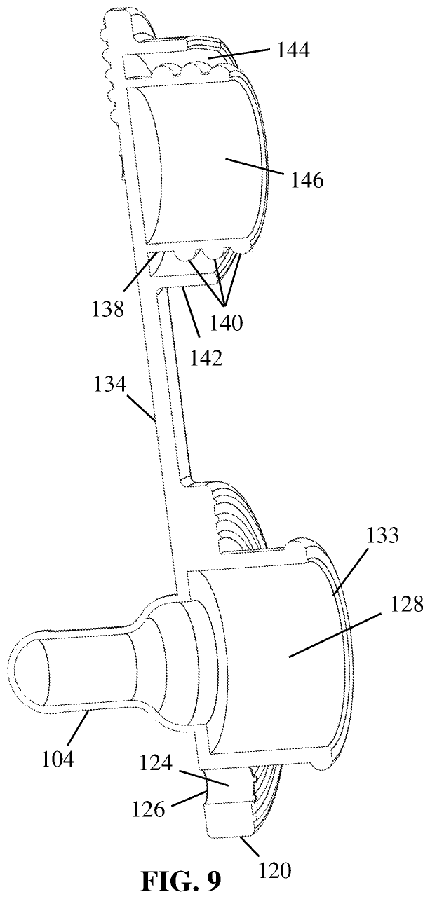

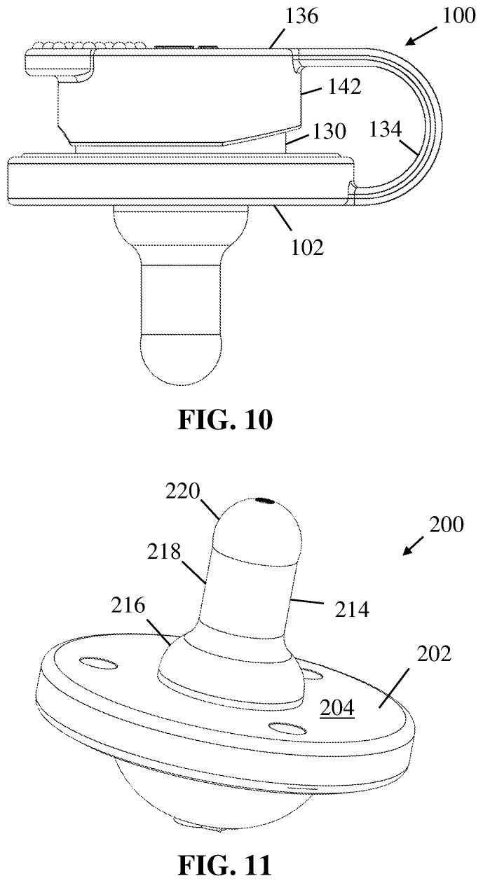

Referring to FIGS. 1-10, a first implementation of a pacifier device (pacifier) (device) 100 is shown. FIGS. 1-9 show the device in an open configuration and FIG. 10 shows it in a closed configuration. The pacifier device includes a retaining member 102, a closure member 136, and a flexible coupler 134 coupling the retaining member and the closure member.

The retaining member includes a flexible nipple (nipple) 104 which, in the implementation shown, includes a hollow rounded base 106 (having a spherical or ellipsoidal shape or otherwise mimicking a breast areola shape), a hollow shaft 108 (which is seen to be cylindrical or substantially cylindrical—the phrase “substantially cylindrical” meaning, herein, less than 20% deviation from cylindricality), and a hollow rounded tip 110 (which, in the implementation shown, has a semispherical, hemispherical, or ellipsoidal shape—as used herein the term “semispherical” means a portion of a sphere that may or may be more or less than half of a sphere). In other implementations the flexible nipple could have other shapes, but the shape shown may in implementations be comforting to an infant inasmuch as it may mimic, to a certain extent, the shape of a nipple and areola of a breast, so that the infant may suck on the device in a manner that mimics nursing. The flexible nipple is seen to not have any opening at the top, so that in sucking or chewing on the nipple there is no liquid or other contents within the device that would exit the nipple.

The flexible nipple is coupled with a swallow shield 112. In the implementation shown the swallow shield is flat, round, and has a certain amount of thickness. The shape and size/dimensions could be altered in other implementations (for example it could be rectangular, triangular, or having any other regular or irregular shape, with smooth edges to prevent injury to infants), but the overall width of the device (perpendicular to a longest length of the nipple) should be sufficient to prevent swallowing of the device 100. In implementations the swallow shield may be sized such that an infant is prevented from placing the entire swallow shield in his/her mouth to begin with. The swallow shield is seen to have a top 114, a bottom 116 (having raised portions 118, which in the implementation shown are raised lines, though they could in other implementations be bumps or other texture, and which may be useful for grip), and a side 120.

A number of air holes 124 are included in the swallow shield and are accessed via openings 126 in the top and bottom of the swallow shield. The air holes are useful for allowing breathing of an infant in a circumstance where the infant places the entire swallow shield within his/her mouth, and/or otherwise ensures that the device does not block breathing of the infant. This is a secondary safety measure, since in implementations the swallow shield should be sized to prevent the infant from placing the entire swallow shield within his/her mouth to begin with.

A reservoir 130 is coupled with the swallow shield. It can be seen from the drawings that the flexible nipple has a hollow interior, the swallow shield has a hollow interior, and the reservoir has a hollow interior, and that these hollow interiors combined form a cavity 128 internal to the pacifier device 100. The reservoir in the implementation shown has a cylindrical or a substantially cylindrical shape, but in other implementations it could have other shapes, such as cuboidal or a three-dimensional shape having a cross section of any n-sided polygon or any other regular or irregular shape, and so forth. The reservoir is seen to have a ridge 132 at its extremity which is useful for providing a seal thereat, which will be described below. Proximate the ridge is an opening 133 of the reservoir which provides access to the cavity, such as for placing a liquid or gel or the like therein.

The closure member 136 shown in the drawings includes an inner coupler 138 having a number of raised seals 140 and an outer coupler 142. Each of these is cylindrical in the implementation shown, though in other implementations they could have any other shape, similar to what is described above for the reservoir, and matching a shape of the reservoir. When the closure member is used to close the cavity the raised seals 140 of the inner coupler abut against the inner sidewall of the reservoir and form a seal thereat. Additionally, in the closed configuration the ridge 132 of the reservoir abuts the inner sidewall of the outer coupler 142 to form a seal thereat, inside the cavity 144 between the inner coupler and outer coupler. A cavity 146 is also present within the inner coupler and is useful for allowing the closure member to seal the opening of the reservoir with a liquid-tight seal while not reducing the cavity 128 volume too much by the presence of the inner coupler therein.

The closure member is also seen to have a tab 148 which is useful to provide a leverage point for removing the closure member when desired, and raised portions 150 (which in the shown implementation are bumps, but in other implementations could be lines or some other texture) which are useful for providing grip during closing and opening of the closure member.

A flowable material, such as a liquid or gel, may be placed inside the cavity of the pacifier device and may be used to provide either a warm or a cool temperature of the device while an infant sucks or chews on the flexible nipple. For example, a flowable material may be heated and then inserted into the cavity through the opening in the reservoir or cooled and then inserted into the cavity through the reservoir opening. Alternatively, a flowable material may be inserted into the cavity and then the entire device may be heated (such as by placing it in heated water or briefly in a microwave oven) or cooled (such as by placing it in a refrigerator or freezer) to warm or cool the flowable material therein. Additionally, a flowable material may be placed within the cavity and the entire pacifier device placed inside a freezer until the flowable material freezes. The pacifier device elements, including the ridge 132 and raised seals 140, allow the freezing to occur without removing the liquid-tight seal of the closure member, and the device 100 may be formed of a material that is flexible enough to allow expansion and contraction during freezing/thawing/heating without rupturing the device.

The liquid-tight seal of the device 100 allows an infant to suck and chew on the device without the liquid exiting the cavity, thus preventing any spilling on the infant and/or on a household floor/carpet or other surface. The closure member allows a user to remove the flowable material within the cavity for replacement and/or cleaning of the cavity, and/or to introduce new flowable material having an appropriate temperature as desired by the user.

The flowable material could be, by non-limiting example: water, salt water, sterilized water, glycerin, alcohol, a non-toxic freezable gel, and so forth.

In implementations the pacifier may be used for infants 0-36 months old for soothing the infants with a warm, cool, or frozen pacifier device and/or for helping with teething. Teething infants may experience pain, itching, and/or irritation/distress where the tooth buds erupt through the gums, and sucking or chewing on cold items, for example, may alleviate this. Additionally, the lips and/or gums of the infant may rest on the rounded base 106 while the infant is using the pacifier, and as the rounded base has a hollow interior which may include the warm or cool or frozen flowable material, the warm or cool temperature of the rounded base may provide a soothing sensation for the infant. When a warm flowable material is placed within the cavity, for instance, the infant's lips may feel a warm sensation at the rounded base that is similar to the warm sensation of a breast areola felt during nursing. In general the warmth of the entire flexible nipple, including the hollow shaft, rounded base, and rounded tip, all of which are warm due to their hollow interiors when there is warm flowable material in the cavity, may provide a breast-like warmth to the child that is similar to that experienced during nursing.

The pacifier device may be formed of a material that provides some level of insulation for the flowable material within the cavity, for example so that the flowable material retains its warmth or cool temperature for an extended amount of time. The closure member may assist with this by preventing ambient-temperature air from reaching the flowable material.

The flexible nipple may be formed of a flexible polymer. In implementations the flexible nipple could be formed of a different material than other portions of the device, and the different components may be securely attached to one another in myriad ways. In other implementations the entire device may be formed of a common flexible material. For example, in the implementation shown the device 100 is entirely formed of silicone. In other implementations it could be formed of a rubber, an elastomer, an elastic polymer, and so forth. While the terms “flexible” and “elastic” are terms of degree—in other words all materials including metals, ceramics, intermetallics, composites, etc., have some elasticity and flexibility—the terms “elastic material” and “flexible material” (and the term “flexible” generally) as used herein are defined as materials/elements “having an elastic modulus (Young's modulus) at least as low as 5 gigapascals (GPa).” In other implementations the elastic or flexible materials or elements may have an elastic modulus at least as low as 1 GPa, or at least as low as 0.1 GPa, or at least as low as 0.01 GPa. In other implementations the elastic materials or elements may have an elastic modulus as least as low as that of silicone. In other implementations the elastic materials or elements may have an elastic modulus as least as low as that of rubber. Devices disclosed herein when made of silicone may have any properties and/or may be made using any techniques that are known in the art for silicone.

The relatively low elastic modulus of the device allows the device to be sucked, chewed on, thrown, etc. without damaging the device and without negatively affecting its utility and ability to hold liquids and be used to pacify children and/or help them during teething.

The cavity of the pacifier device may be entirely filled with a flowable material, or only partially filled. In implementations the flowable material fills at least a majority of the cavity.

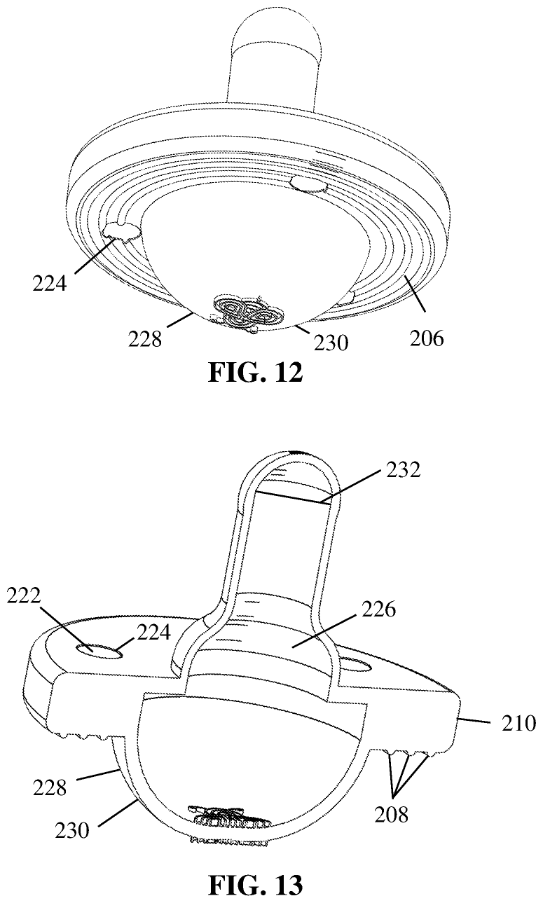

Referring now to FIGS. 11-13, an implementation of a pacifier device (pacifier) (device) 200 is shown. This device is similar in many respects to the device 100, having for example: a similar or identical flexible nipple 214 with a rounded base 216, hollow shaft 218, and rounded tip 220; a swallow shield 202 with a top 204, bottom 206 having raised portions 208, and side 210; and air holes 222 accessible through openings 224. The reservoir 228 is seen to have a different shape than the reservoir of device 100, which is seen to be a semisphere 230 or hemisphere. The cavity 226 is formed by hollow interiors of the flexible nipple, swallow shield, and reservoir, and is seen to be substantially filled with a flowable material 232, which may have any of the properties/materials as those described above for other devices. The flowable material is shown to not entirely fill the cavity, but in other implementations it could entirely fill the cavity. In implementations some amount of air or other gas may be left within the cavity to allow for easier expansion of the flowable material during heating and/or cooling. The cavity 226 is seen to be entirely contained within the device 200 so that there is no opening or the like providing access thereto. Accordingly, the flowable material is not replaced, but simply is retained therein indefinitely. The device 200 may be heated and/or cooled/frozen in like manner as that described above for device 100.

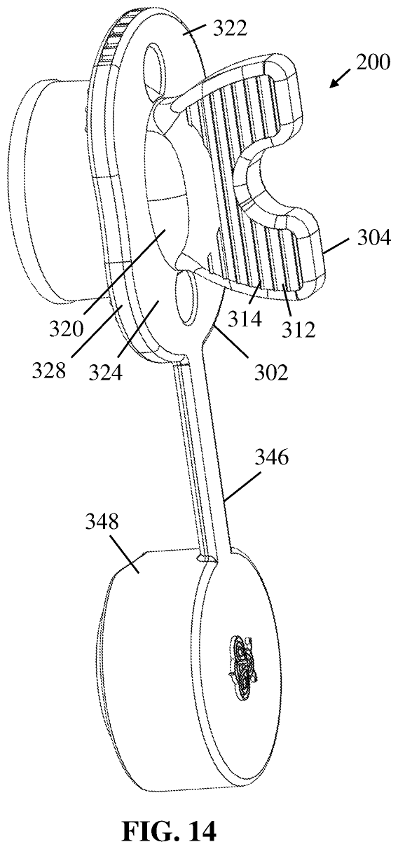

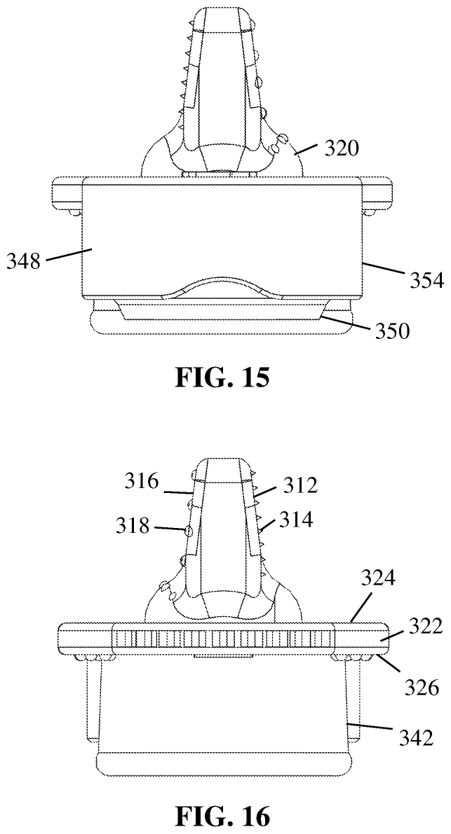

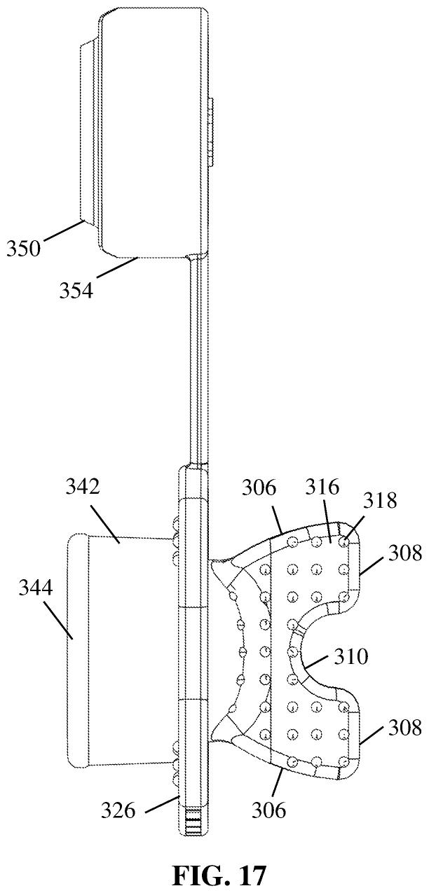

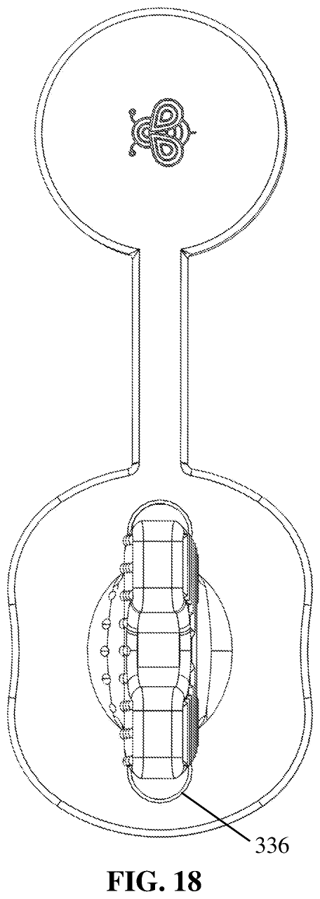

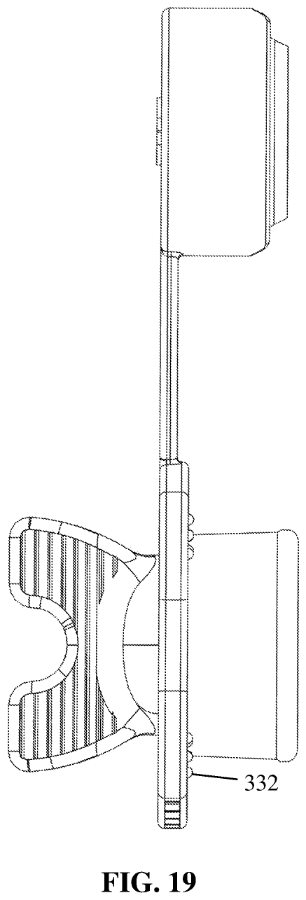

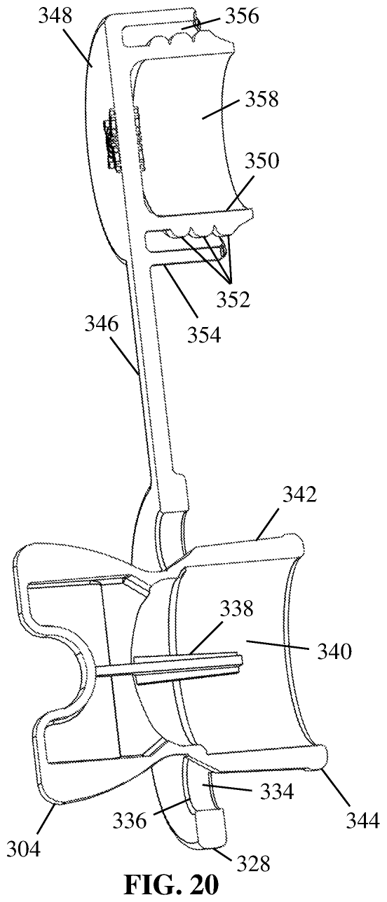

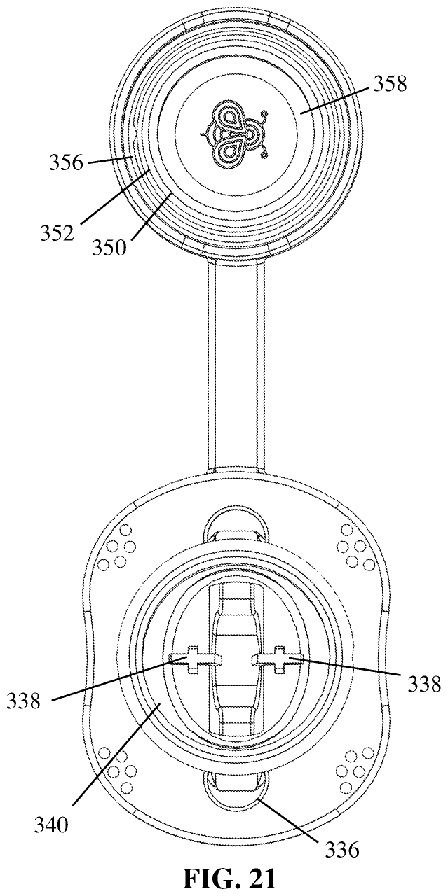

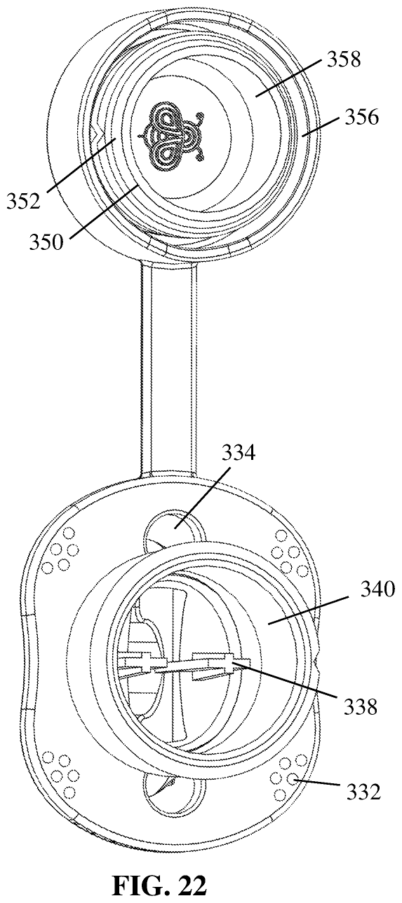

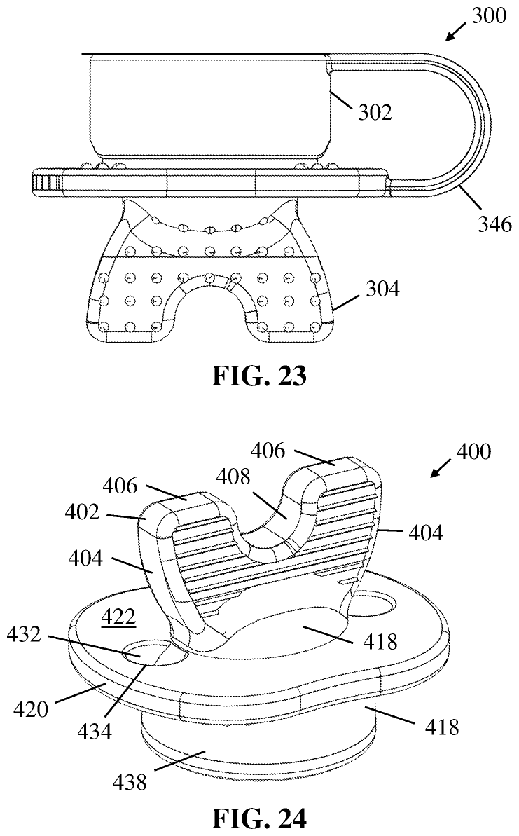

Referring now to FIGS. 14-23, an implementation of a teething device (teether) (device) 300 is shown. This device is similar in many respects to the device 100, having for example: a similar or identical swallow shield 322 with a top 324, bottom 326 having raised portions 332, and side 328; air holes 334 accessible through openings 336; reservoir 342 with ridge 344; flexible coupler 346; closure member 348 having an inner coupler 350 with raised seals 352, outer coupler 354, a cavity 356 between the inner coupler and outer coupler, and a cavity 358 within the inner coupler; and a cavity 340 for holding a flowable material.

The teething device 300 is different, however, in that its retaining member 302 includes a flexible teething member (teething member) 304 that forms a U-shape and is shaped and sized to simultaneously contact all twenty erupted deciduous (baby) teeth of an infant. Accordingly, an infant may bite down on the teething member 304 and have it contact all of his teeth. This is not the case with the flexible nipple of the above pacifier devices which, though they may be used for teething as well, are not shaped for such full coverage of the infant's teeth. In order to shape the teething member to fit the infant's mouth/teeth, it is seen to have semi-elliptical sides 306 and a flat top 308 with a semi-elliptical recess 310 therein. The semi-elliptical recess may be useful for receiving a tongue of an infant or otherwise make space for the infant's tongue. A first side 312 of the teething member is seen to have raised lines 314, and a second side 316 is seen to have raised bumps 318, though other raised or recessed portions or other texture may be provided on either side and may be useful for providing a pleasant texture to the infant while chewing or biting the teething member. The teething member is seen to have a rounded base 320 which may provide the same benefits as those rounded bases 106/216 described above for the pacifier devices.

The flexible teething member, swallow shield, and reservoir of device 300 are all seen to include hollow interiors which together define cavity 340. Structural supports 338 are also included in the device and may provide for some rigidity to portions of the device. They may also help to ensure that frozen flowable material, such as ice, does not fall out of the device if the closure member is released accidentally/unintentionally or released by the infant. The cross section of the device reveals that the hollow interior of the flexible teething member has a narrower portion with a wider portion above it, which also helps to ensure that frozen flowable material does not exit the cavity immediately upon removing the closure member.

The teething device 300 may be filled with warm or cold flowable material, or may be frozen, as described above for the pacifier devices, and may otherwise include any of the characteristics and advantages of the pacifier devices that are clearly appliable to it. It may be made of similar/identical materials and may otherwise have similar/identical properties to the pacifier devices. Because the flexible teething member has a hollow interior forming part of the cavity of the device, the heat or coolness of the flowable material is transferred to the infant's gum's mouth through the flexible teething member.

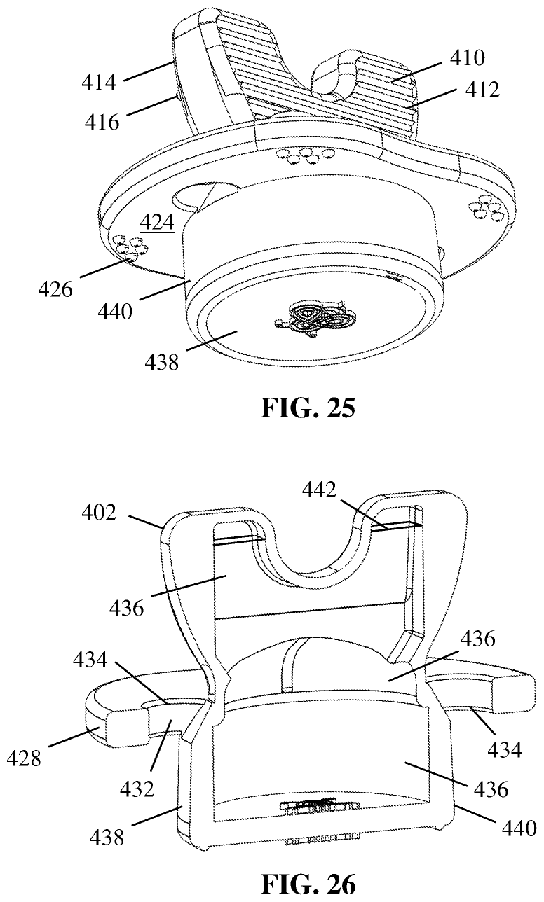

Referring now to FIGS. 24-26, an implementation of a teething device (teether) (device) 400 is shown. This device is similar in many respects to the device 300, having for example: a similar or identical flexible teething member 402 having a U-shape and having semi-elliptical sides 404, a flat top 406, a semi-elliptical recess 408, a first side 410 having raised lines 412, a second side 414 having raised bumps 416, and rounded base 418; a swallow shield 420 having a top 422, bottom 424 with raised portions 426, side 428, and air holes 432 accessible through openings 434.

The reservoir 438 is seen to have a relatively similar shape to the reservoir of device 300, in that it forms a cylinder 440 or is substantially cylindrical. The cavity 436 is formed by hollow interiors of the flexible teething member, swallow shield, and reservoir, and is seen to be substantially filled with a flowable material 442, which may have any of the properties/materials as those described above for other devices. The flowable material is shown to not entirely fill the cavity, but in other implementations it could entirely fill the cavity. In implementations some amount of air or other gas may be left within the cavity to allow for easier expansion of the flowable material during heating and/or cooling. The cavity 436 is seen to be entirely contained within the device 400 so that there is no opening or the like providing access thereto. Accordingly, the flowable material is not replaced, but simply is retained therein indefinitely. The device 400 may be heated and/or cooled/frozen in like manner as that described above for the other devices described herein.

In implementations in which the terms ellipse, elliptical, ellipsoid, ellipsoidal, etc., are used herein, embodiments which are spherical or spheroidal or circular are also intended to be included, as a circle is a special form of ellipse.

The removable closure members disclosed herein may allow users to precisely control the temperature of flowable material within the cavity. All of the devices disclosed herein may be useful for infants 0-36 months old, and any of the flowable materials or other elements of any specific device may be used for any other specific device disclosed herein.

In places where the phrase “one of A and B” is used herein, including in the claims, wherein A and B are elements, the phrase shall have the meaning “A or B.” This shall be extrapolated to as many elements as are recited in this manner, for example the phrase “one of A, B, and C” shall mean “A, B, or C,” and so forth.

Any of the teething devices and/or pacifier devices disclosed herein may also be accurately called “oral devices” inasmuch as they are configured for oral care and/or for use within the oral cavity of an infant.

In places where the description above refers to specific implementations of pacifiers and teething devices and related methods, one or more or many modifications may be made without departing from the spirit and scope thereof. Details of any specific implementation/embodiment described herein may, wherever possible, be applied to any other specific implementation/embodiment described herein.

What is claimed is:

1. An oral device, comprising:
a flexible member comprising a hollow interior at least partially defining a cavity, the flexible member configured to be used as one of a pacifier and a teething member;
a swallow shield coupled with the flexible member and comprising a hollow interior at least partially defining the cavity, the swallow shield configured to prevent swallowing of the oral device;
a reservoir coupled with the swallow shield and comprising a hollow interior at least partially defining the cavity, the reservoir comprising an opening providing access to the cavity; and
a closure member configured to couple with the reservoir in a liquid-tight configuration to prevent access to the cavity through the opening;
wherein the flexible member is formed of a flexible polymer;
wherein the opening is configured to allow introduction of a liquid into the cavity and to allow removal of the liquid from the cavity;
wherein the flexible member is configured to be one of chewed and sucked, while the liquid is within the cavity, without any of the liquid exiting the cavity; and
wherein the oral device is configured to allow freezing of the liquid within the cavity without removing the liquid-tight configuration of the closure member and without rupturing the oral device.

2. The oral device of claim 1, wherein the flexible member comprises a flexible teething member sized and shaped to simultaneously contact all twenty erupted deciduous teeth of an infant.

3. The oral device of claim 2, wherein the flexible teething member forms a U-shape.

4. The oral device of claim 1, wherein the flexible member comprises a flexible nipple.

5. The oral device of claim 1, wherein the oral device comprises no access to the cavity from outside the oral device except through the opening.

6. The oral device of claim 1, wherein the closure member comprises an inner coupler and an outer coupler, wherein the inner coupler is configured to provide a seal at an interior of the reservoir, and wherein the outer coupler is configured to provide a seal at an exterior of the reservoir.

7. The oral device of claim 1, wherein the flexible polymer forms all of the oral device.

8. The oral device of claim 1, wherein the swallow shield comprises air holes therethrough.

9. The oral device of claim 1, further comprising a flexible coupler permanently coupling the closure member with one of the flexible member, the swallow shield, and the reservoir, when the closure member is not contacting the reservoir.

10. A teething device, comprising:
a flexible teething member comprising a hollow interior at least partially defining a cavity;
a swallow shield coupled with the flexible teething member and comprising a hollow interior at least partially defining the cavity, the swallow shield configured to prevent swallowing of the teething device;
a reservoir coupled with the swallow shield and comprising a hollow interior at least partially defining the cavity; and
a flowable material filling at least a majority of the cavity, the flowable material comprising one of a liquid and a gel;
wherein the flexible teething member is formed of a flexible polymer;
wherein the cavity is fully enclosed within the teething device and wherein the teething device comprises no opening providing access to the cavity from outside the teething device;
wherein the flexible teething member is configured to be chewed, while the flowable material is within the hollow interior of the flexible teething member, without any of the flowable material exiting the cavity; and
wherein the teething device is configured to allow freezing of the flowable material within the cavity without rupturing the teething device.

11. The teething device of claim 10, wherein the flexible teething member is sized and shaped to simultaneously contact all twenty erupted deciduous teeth of an infant.

12. The teething device of claim 10, wherein the flexible teething member comprises a flexible nipple comprising a hollow shaft topped with a hollow rounded tip.

13. The teething device of claim 12, wherein the flexible nipple comprises a rounded base coupled with the swallow shield, the rounded base comprising one of a semi-ellipsoidal shape and a semi-spherical shape.

14. The teething device of claim 10, wherein the flexible polymer forms all of the teething device.

15. The teething device of claim 10, wherein the flexible teething member comprises one of raised bumps and raised lines on a surface thereof.

16. The teething device of claim 10, wherein the flexible teething member forms a U-shape.

17. The teething device of claim 10, wherein the swallow shield comprises air holes therethrough.

18. A pacifier device, comprising:
a flexible nipple comprising a hollow shaft topped with a rounded tip, the rounded tip comprising no opening therethrough, the flexible nipple comprising a hollow interior at least partially defining a cavity;
a swallow shield coupled with the flexible nipple and comprising a hollow interior at least partially defining the cavity, the swallow shield configured to prevent swallowing of the pacifier device;
a reservoir coupled with the swallow shield and comprising a hollow interior at least partially defining the cavity; and
a flowable material filling at least a majority of the cavity, the flowable material comprising one of a liquid and a gel;
wherein the flexible nipple is formed of a flexible polymer;
wherein the cavity is fully enclosed within the pacifier device and wherein the pacifier device comprises no opening providing access to the cavity from outside the pacifier device;
wherein the flexible nipple is configured to be chewed, while the flowable material is within the hollow interior of the flexible nipple, without any of the flowable material exiting the cavity; and
wherein the pacifier device is configured to allow freezing of the flowable material within the cavity without rupturing the pacifier device.

19. The pacifier device of claim 18, wherein the flexible nipple comprises a hollow rounded base coupled with the swallow shield, the hollow rounded base comprising one of a semi-ellipsoidal shape and a semi-spherical shape.

20. The pacifier device of claim 10, wherein the swallow shield comprises air holes therethrough.
